(19) United States
(12) Patent Application Publication
(10) Pub. No.: US 2023/0357094 A1
(43) Pub. Date: Nov. 9, 2023

(54) STABILIZED UREA-BASED CORE-SHELL FERTILIZER PARTICLES

(71) Applicant: SABIC Global Technologies B.V., Bergen op Zoom (NL)

(72) Inventors: Rajamalleswaramma KORIPELLY, Bangalore (IN); Satish BURLA, Bangalore (IN); Ravi HEGDE, Bangalore (IN); Samik GUPTA, Bangalore (IN)

(73) Assignee: SABIC Global Technologies B.V., Bergen op Zoom (NL)

(21) Appl. No.: 17/777,507

(22) PCT Filed: Nov. 26, 2020
(86) PCT No.: PCT/IB2020/061189

§ 371 Date: May 17, 2022

(30) Foreign Application Priority Data
Nov. 27, 2019 (IN) 201911048587

(51) Int. Cl. C05C 9/00; C05G 5/35; C05G 3/90; C05G 3/80; C05G 5/40

(52) U.S. Cl. CPC C05C 9/005; C05G 5/35; C05G 3/90; C05G 3/80; C05G 5/40

(57) ABSTRACT

Fertilizer particles containing a core and a shell is described. The core can contain urea, a pH buffering agent, and an urease inhibitor, and the shell can contain urea and can cover at least a portion of an outer surface of the core. The core can include 20 wt. % to 80 wt. % urea, based on the total weight of the core, and the shell can include 50 wt. % to 100 wt. % urea, based on the total weight of the core.

### CROSS REFERENCE TO RELATED APPLICATIONS

This application claims priority to and the benefit of priority of Indian Patent Application No.: 201911048587 filed Nov. 27, 2019, which is hereby incorporated by reference in its entirety.

### BACKGROUND OF THE INVENTION

### A. Field of the Invention

The invention generally concerns urea containing fertilizer particles having a core-shell structure. In particular, the core-shell fertilizer particles can include a core containing urea, a pH buffering agent, and an urease inhibitor, and a shell containing urea. The core and the shell can have a different compositional make-up, and the core can help stabilize the urea containing shell (e.g., reduce hydrolyzation and/or nitrification of the urea in the shell).

### B. Description of Related Art

To increase crop yield and satisfy the growing needs of an increasing population, more fertilizers are being used in agriculture. However, continuous use of fertilizer can lead to nutrient imbalance and loss of soil fertility. In addition, extensive use of urea fertilizer, due to its rapid hydrolysis and nitrification in the soil by soil bacteria, can cause deterioration of soil health and other environmental problems such as greenhouse emissions and groundwater contamination.

Hydrolysis and nitrification of urea in soil can be counteracted by adding urease inhibitors and nitrification inhibitors to the fertilizer. Urease inhibitors reduce the amount of urea hydrolyzed, which reduces the amount of nitrogen lost through ammonia volatilization. Nitrification inhibitors reduce the rate of conversion of ammonium into nitrate, which also reduces the amount of nitrogen lost.

While use of urease inhibitors and nitrification inhibitors in fertilizers has been employed as a solution to the problems of urea hydrolysis and nitrification, there are certain difficulties in using these fertilizers. For example, International application publication WO2017013572 A1 describes fertilizer particles having a core containing a binder and an urease inhibitor and/or a nitrification inhibitor. The core can be prepared through an extrusion process. Binders such as Plaster of Paris (POP) and bleached wheat flour (BWF) can be used to make the core composition amenable to the extrusion process and also to help the extruded core to withstand the post-extrusion processes.

### SUMMARY OF THE INVENTION

The inventors have found that in some instances some binders can cause fouling and clogging of the machines that are used in making and using the fertilizer particles. For example, while POP and BWF can function as efficient binders, in certain instances may also result in fouling and clogging of the machines that are used in making and using the fertilizer particles. Additionally, using BWF may create risk for a dust explosion.

The inventors have discovered a solution to at least some of the aforementioned problems. In one aspect, a solution resides in providing a core-shell structured fertilizer particle with a core containing urea, a pH buffering agent, and an urease inhibitor, and a shell containing urea. The core can be prepared by processes such as pelletization, granulation, compaction, or extrusion. It was discovered that the core containing the urea, the pH buffering agent (e.g., CaCO₃), and the urease inhibitor can reduce fouling and clogging issues during manufacture of the core. Further, these core ingredients also serve to protect the urease inhibitor (e.g., from degradation) during and after manufacture of the core. In one aspect, and without wishing to be bound by theory, it is believed that the urea and urease inhibitor in the core can act to stabilize each other during the core manufacturing process. Further, it is believed that the urea in the core can also help to keep the core from breaking or crumbling during the fertilizer manufacturing process and/or during storage or use of the fertilizer particles of the present invention. Once produced, the core can be coated with the urea-based shell (e.g., by drying or solidifying an aqueous urea solution on at least a portion of a surface of the core). This structured core-shell fertilizer particle allows for a more commercially scalable production process (e.g., avoids clogging and/or fouling during core processing) and allows for the protection of the urea-based shell from hydrolyzation via the presence of the stabilized urease inhibitor in the core. Notably, and in certain aspects, flour (e.g., BWF) and POP is not present in the core or in the entire fertilizer particle or is present in amounts of 2 wt. % or less, preferably 0 wt. %.

One aspect of the present invention is directed to a core-shell fertilizer particle containing a core and a shell, where the shell covers at least a portion of an outer surface of the core. The core can contain urea, a pH buffering agent, and an urease inhibitor. The core can optionally contain a nitrification inhibitor, a filler, and/or a polymer thickener. The shell can contain urea. The shell can optionally contain a nitrification inhibitor. In some aspects, the core can contain 20 wt. % to 80 wt. %, preferably 40 wt. % to 80 wt. %, or more preferably 45 wt. % to 55 wt. % or 65 wt. % to 75 wt. % of urea, based on the total weight of the core. In some aspects, the shell can contain, 50 wt. % to 100 wt. %, preferably 80 wt. % to 100 wt. %, more preferably 90 wt. % to 100 wt. %, of urea, based on the total weight of the shell. In some aspects, the shell can contain 95 wt. % to 100 wt. % of urea, based on the total weight of the shell. In some aspects, the pH buffering agent can be CaCO₃, Na₂CO₃, K₂CO₃, MgO, KH₂PO₄, NaHCO₃, or MgCO₃, or any combination thereof. In some aspects, the pH buffering agent is preferably CaCO₃. In some aspects, the core can contain 15 wt. % to 80 wt. %, or 15 wt. % to 60 wt. %, or 20 wt. % to 45 wt. %, or 15 wt. % to 30 wt. %, or 40 wt. % to 60 wt. %, of the pH buffering agent, based on the total weight of the core. In some aspects, the core can contain 15 wt. % to 60 wt. %, or 15 wt. % to 50 wt. %, or 20 wt. % to 45 wt. %, or 25 wt. % to 40 wt. %, or 25 wt. % to 30 wt. %, or 40 wt. % to 60 wt. %, of CaCO₃, based on the total weight of the core. In some aspects, the CaCO₃ can be included in the core as chalk powder. In some aspects, the urease inhibitor can include a thiophosphoric triamide derivative. In some aspects, the thiophosphoric triamide derivative can be N-(n-butyl) thiophosphoric triamide (NBPT). In some aspects, the core can contain 0.1 wt. % to 5 wt. % of the urease inhibitor such a thiophosphoric triamide derivative, based on the total weight of the core. In some aspects, the core can contain 0.1 wt. % to 5 wt. % of NBPT, based on the total weight of the core. In some aspects, the core can further contain 0.1 wt. % to 7 wt. %, or 0.1 wt. % to 5 wt. % of water, based on the total weight of the core. In some aspects, the core can further contain a polymer thickener. In some aspects, the polymer thickener can have a melting point greater than 150° C. In some aspects, the polymer thickener can include hydroxypropyl methylcellulose (HPMC), carboxymethyl cellulose, polyethylene glycol (PEG), guar gum, locust bean gum, xanthan gum, a natural gum, lignosulfonates, or hydroxyethylcellulose or any combination thereof, preferably HPMC. In some aspects, the core can contain 0.1 wt. % to 5 wt. % of the polymer thickener, based on the total weight of the core. In some aspects, the core can contain 0.1 wt. % to 5 wt. % of HPMC. In some aspects, the core can further contain a nitrification inhibitor. In some aspects, the nitrification inhibitor can include dicyandiamide (DCD). In some aspects, the core can contain 5 wt. % to 35 wt. % of the nitrification inhibitor, based on the total weight of the core. In some aspects, the core can contain 5 wt. % to 35 wt. % of DCD, based on the total weight of the core. In some aspects, the core can contain a filler. In some aspects, the filler can be rice husk, MgO, CaO, bone mill powder, or CaCO₃, or any combination thereof. In some aspects, the pH buffer, such as CaCO₃, in the core can also function as a filler in addition to its function as a pH buffering agent. In some aspects, the combined wt. % of the urea, CaCO₃, one or more urease inhibitor, water, and optionally a nitrification inhibitor and/or a polymer thickener in the core is 98 wt. % or higher, based on the total weight of the core.

In some aspects, the core can contain 45 wt. % to 60 wt. %, or 65 wt. % to 75 wt. % of urea, 20 to 45 wt. %, or 22 wt. % to 45 wt. %, or 20 wt. % to 30 wt. %, or 22 wt. % to 30 wt. %, of the pH buffering agent such as CaCO₃, 0.1 wt. % to 7 wt. % of water, and 1 wt. % to 3 wt. % of the urease inhibitor such as NBPT, based on the total weight of the core and the shell can contain 85 wt. % to 100 wt. % of urea, based on the total weight of the shell. In some aspects, the core can contain 65 wt. % to 75 wt. % of urea, 20 wt. % to 30 wt. % of the pH buffering agent such as CaCO₃, 0.1 wt. % to 7 wt. % of water, 0.5 wt. % to 5 wt. % of the polymer thickener such as HPMC, and 1 wt. % to 3 wt. % of the urease inhibitor such as NBPT, based on the total weight of the core and the shell can contain 85 wt. % to 100 wt. % of urea, based on the total weight of the shell. In some aspects, the core can contain 45 wt. % to 60 wt. % of urea, 22 wt. % to 40 wt. % of the pH buffering agent such as CaCO₃, 0.1 wt. % to 7 wt. % of water, 20 wt. % to 25 wt. % of the nitrification inhibitor such as DCD, and 1 wt. % to 3 wt. % of the urease inhibitor such as NBPT, based on the total weight of the core, and the shell can contain 85 wt. % to 100 wt. % of urea, based on the total weight of the shell. In some aspects, the core can contain 45 wt. % to 60 wt. % of urea, 22 wt. % to 45 wt. % of the pH buffering agent such as CaCO₃, 0.1 wt. % to 7 wt. % of water, 0.5 wt. % to 5 wt. % of the polymer thickener such as HPMC, and 1 wt. % to 3 wt. % of the urease inhibitor such as NBPT, based on the total weight of the core, and the shell can contain 85 wt. % to 100 wt. % of urea, based on the total weight of the shell. In some aspects, the core can contain 20 wt. % to 75 wt. % of urea, 20 wt. % to 60 wt. % of the pH buffering agent such as CaCO₃, 0.1 wt. % to 7 wt. % of water, 0.5 wt. % to 5 wt. % of the polymer thickener such as HPMC, and 1 wt. % to 3 wt. % of the urease inhibitor such as NBPT, based on the total weight of the core and the shell can contain 85 wt. % to 100 wt. % of urea, based on the total weight of the shell.

In some aspects, the core and/or the shell can contain less than 2 wt. %, or less than 1 wt. %, or is substantially free of Plaster of Paris, and/or a flour, such as bleached wheat flour (e.g., BWF), based on the total weight of the core. In some aspects, the core and/or the shell can contain less than 2 wt. %, or less than 1 wt. %, or is substantially free, based on the total weight of the core, of starch, gluten, kaolin, bentonite, polyethylene glycol, and/or polycaprolactone. In some aspects, the core and/or shell is substantially free of a nitrification inhibitor. In some aspects, the core and/or shell is substantially free of a polymer thickener. In some aspects, the shell contains less than 2 wt. % or less than 1 wt. % or less than 0.1 wt. % or is substantially free of a pH buffering agent, a urease inhibitor, a polymer thickener, and/or a nitrification inhibitor, based on the total weight of the shell.

The core can be of any suitable shape, non-limiting shapes includes spherical, cuboidal, cylindrical, a puck shape, oval, and oblong shapes. In some aspects, the core can be of cylindrical shape with a circular, elliptical, ovular, triangular, square, rectangular, pentagonal, or hexagonal cross section, although cylindrical shaped core having a cross-section of other shapes can also be made. In some aspects, the core can have a dimension such as length, width, height and/or cross-sectional diameter between 0.5 mm to 2.5 mm. In some aspects, the core can have a substantially cylindrical shape with a length of the cylinder 0.5 mm to 2 mm, or 0.7 mm to 1.6 mm, and a circular cross-section with diameter 0.5 mm to 1.5 mm, or 0.8 mm to 1.2 mm, wherein the cross-section is taken along a plane perpendicular to the length of the cylinder. In some aspects, the shell can form a coat with a thickness of 0.1 mm to 8 mm, or 1 mm to 6 mm, or 2 mm to 4 mm over at least a portion of the outer surface of the core. The core-shell fertilizer particles can also have a variety of shape and sizes. Non-limiting shapes of the core-shell fertilizer particles include spherical, cylindrical, puck, oval, or oblong shape. In some aspects, the core-shell fertilizer particle can have a longest dimension 1 to 8 mm. In some particular aspects, the core can have a substantially cylindrical shape with length 0.7 mm to 1.6 mm and a substantially circular cross-section with diameter 0.8 mm to 1.2 mm, the shell can form a coat over at least a portion of the outer surface of the core and the core-shell fertilizer particle can have a substantially spherical shape with diameter 1 mm to 5 mm, 1 mm to 4 mm, 2 mm to 5 mm, or 2 mm to 4 mm.

In some aspects, the shell can cover at least 10%, 20%, 30%, 40% or 10% to 50% of the outer surface of the core. In other aspects, the shell can cover a majority (e.g., greater than 50%) of the outer surface of the core. In some aspects, the shell can cover greater than 50%, at least 60%, at least 70%, at least 80%, at least 90%, or 100% of the outer surface of the core. In certain aspects, the shell can cover 60% to 100% or 80% to 100% or 90% to 100% of the outer surface of the core. In some aspects, the weight ratio of the shell to the core in the core-shell fertilizer particle can be about 2:1 to 9:1. In some aspects, the shell can make up about 60% to 90% of the total weight of the fertilizer particle. In other aspects, the core can make up about 60% to 90% of the total weight of the fertilizer particle. In some aspects, the core can be a pelletized, a compacted, agglomerated and/or a granulated core. In some aspects, the shell can contain a solidified aqueous urea melt, coated onto at least a portion of the outer surface of the core. In certain aspects, a core-shell fertilizer particle can contain two or more cores. The two or more cores can be covered by a shell. In some aspects, the core can be substantially homogeneous and the shell can be substantially homogeneous, and the composition of the core can be different from the composition of the shell making the overall core-shell fertilizer particle heterogeneous. A core is substantially homogeneous if the compositional make-up for a 0.2 mm×0.2 mm×0.2 mm cube at any position of the core is substantially similar or the same when compared to a 0.2 mm×0.2 mm×0.2 mm cube at any other position of the core. A shell is substantially homogeneous if the compositional make-up for a 0.2 mm×0.2 mm×0.2 mm cube at any position of the shell is substantially similar or the same when compared to a 0.2 mm×0.2 mm×0.2 mm cube square at any other position of the shell. Substantially similar can include the presence of the same ingredients but having a slight variation in wt. % of the ingredients (e.g., less than 10% or less than 5% or less than 2%, or less than 1% variation by weight per ingredient).

In some aspects, the core-shell fertilizer particle can be included in a fertilizer blend or a compounded fertilizer.

One aspect of the present invention is directed to a method of making a core-shell fertilizer particle. The method can include forming a core having an outer surface, contacting at least a portion of the outer surface of the core with an urea containing solution or urea melt, and cooling and/or drying the urea solution or urea melt in contact with the at least a portion of the outer surface of the core to form a shell. In some aspects, the contacting of the urea solution or urea melt and the at least a portion of the outer surface of the core can include spraying the urea solution or urea melt onto the at least a portion of the outer surface at a temperature of 110° C. to 140° C. In some particular aspects, the contacting of the urea solution or urea melt and the at least a portion of the outer surface of the core can be performed in a granulator with a bed temperature during the contacting process of 80° C. to 110° C. In some aspects, the urea solution can be an aqueous urea solution (e.g., a 90 wt. %-96 wt. % aqueous urea solution). In some aspects, the urea solution can be an aqueous solution containing urea melt. In some aspects, the core can be formed by a pelletizing process such as a pelletizing press process, a compacting process, an extrusion process, and/or a granulating process.

One aspects, of the present invention is directed to a method of fertilizing, the method comprising applying a core-shell fertilizer particle to at least a portion of a soil, a crop, or the soil and the crop. The nitrogen in the fertilizer particles of the present invention can be stabilized when the particles are exposed to soils. Because of the presence of urease inhibitors and/or nitrification inhibitors in the particles, the fertilizer particles suffer less loss of nitrogen due to hydrolysis and/or nitrification than would otherwise occur. In some embodiments, less than 20 wt. % of the nitrogen in the fertilizer particle is lost via ammonia volatilization after being exposed to soil for 20 days. In some embodiments, the amount of nitrogen in the fertilizer particle lost via ammonia volatilization after being exposed to soil for 20 days is less than 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 wt. % or is between any two of those values.

Also disclosed is a method of enhancing plant growth comprising applying to soil an effective amount of a composition comprising any of the fertilizer particles of the present invention.

In the context of the present invention, at least the following 29 aspects are described.

Aspect 1 is directed to a core-shell fertilizer particle comprising: a core comprising urea, a pH buffering agent, and an urease inhibitor; and a shell comprising urea, wherein the shell covers at least a portion of an outer surface of the core.

Aspect 2 is directed to the core-shell fertilizer particle of aspect 1, wherein the core comprises 20 wt. % to 80 wt. %, preferably 40 wt. % to 80 wt. %, urea, based on the total weight of the core.

Aspect 3 is directed to the core-shell fertilizer particle of any one of aspects 1 to 2, wherein the shell comprises 50 wt. % to 100 wt. %, preferably 85 wt. % to 100 wt. %, urea, based on the total weight of the shell.

Aspect 4 is directed to the core-shell fertilizer particle of any one of aspects 1 to 3, wherein the core comprises 15 wt. % to 80 wt. %, preferably 20 wt. % to 60 wt. %, of the pH buffering agent based on the total weight of the core.

Aspect 5 is directed to the core-shell fertilizer particle of any one of aspects 1 to 4, wherein the pH buffering agent is CaCO₃, Na₂CO₃, K₂CO₃, MgO, KH₂PO₄, NaHCO₃, or MgCO₃ or any combination thereof, preferably CaCO₃.

Aspect 6 is directed to the core-shell fertilizer particle of any one of aspects 1 to 5, wherein the urease inhibitor comprises a thiophosphoric triamide derivative, preferably N-(n-butyl) thiophosphoric triamide (NBPT).

Aspect 7 is directed to the core-shell fertilizer particle of any one of aspects 1 to 6, wherein the core comprises 0.1 wt. % to 5 wt. % of the urease inhibitor, based on the total weight of the core.

Aspect 8 is directed to the core-shell fertilizer particle of any one of aspects 1 to 7, wherein the core comprises 0.1 wt. % to 7 wt. % of water, based on the total weight of the core.

Aspect 9 is directed to the core-shell fertilizer particle of any one of aspects 1 to 8, wherein the core further comprises a polymer thickener and/or a filler.

Aspect 10 is directed to the core-shell fertilizer particle of aspect 9, wherein the polymer thickener comprises hydroxypropyl methylcellulose (HPMC), carboxymethyl cellulose, polyethylene glycol (PEG), guar gum, locust bean gum, xanthan gum, a natural gum, lignosulfonate, or hydroxyethylcellulose or any combination thereof, preferably HPMC, and/or wherein the filler comprises MgO, CaO, bone mill powder, or rice husk, or any combination thereof.

Aspect 11 is directed to the core-shell fertilizer particle of any one of aspects 9 to 10, wherein the core comprises 0.1 wt. % to 5 wt. % of the polymer thickener, based on the total weight of the core.

Aspect 12 is directed to the core-shell fertilizer particle of any one of aspects 1 to 11, wherein the core further comprises a nitrification inhibitor.

Aspect 13 is directed to the core-shell fertilizer particle of aspect 12, wherein the nitrification inhibitor comprises dicyandiamide (DCD).

Aspect 14 is directed to the core-shell fertilizer particle of any one of aspects 12 to 13, wherein the core comprises 5 wt. % to 35 wt. % of the nitrification inhibitor, based on the total weight of the core.

Aspect 15 is directed to the core-shell fertilizer particle of any one of aspects 1 to 14, wherein combined wt. % of the urea, CaCO₃, one or more urease inhibitor, water, and optionally a nitrification inhibitor and/or a polymer thickener in the core is 98 wt. % or higher, based on the total weight of the core.

Aspect 16 is directed to the core-shell fertilizer particle of any one of aspects 1 to 15, wherein: the core comprises, based on the total weight of the core: 45 wt. % to 60 wt. % or 65 wt. % to 75 wt. % of urea; 20 wt. % to 60 wt. %, preferably 20 wt. % to 45 wt. %, of CaCO₃; 1 wt. % to 3 wt. % of the urease inhibitor, wherein the urease inhibitor is N-(n-butyl) thiophosphoric triamide (NBPT); 0.1 wt. % to 3 wt. % of water; and the shell comprises, based on the total weight of the shell: 85 wt. % to 100 wt. % urea.

Aspect 17 is directed to the core-shell fertilizer particle of aspect 16, wherein the core further comprises 0.5 wt. % to 3 wt. % of hydroxypropyl methylcellulose (HPMC), based on the total weight of the core.

Aspect 18 is directed to the core-shell fertilizer particle of any one of aspects 16 to 17, wherein the core further comprises 20 wt. % to 25 wt. % of dicyandiamide (DCD), based on the total weight of the core.

Aspect 19 is directed to the core-shell fertilizer particle of any one of aspects 1 to 18, wherein the shell does not include CaCO₃ or a urease inhibitor, or both.

Aspect 20 is directed to the core-shell fertilizer particle of any one of aspects 1 to 19, wherein the core has a substantially cylindrical shape, preferably with a length 0.7 mm to 1.6 mm and a cross-sectional diameter 0.8 mm to 1.2 mm along a plane perpendicular to the length of the cylinder, the shell forms a coat over at least a portion of the outer surface of the core and the core-shell fertilizer is substantially spherical in shape, preferably with a diameter 2 mm to 4 mm.

Aspect 21 is directed to the core-shell fertilizer particle of any one of aspects 1 to 20, wherein the core is a pelletized, compacted, or granulated core and the shell is a solidified aqueous urea melt solution or a solidified urea melt coated onto at least a portion of the surface of the core.

Aspect 22 is directed to the core-shell fertilizer particle of any one of aspects 1 to 21, wherein the shell covers a majority of or the entire outer surface of the core.

Aspect 23 is directed to the core-shell fertilizer particle of any one of aspects 1 to 22, wherein the core is a homogeneous core and the shell is a homogeneous shell.

Aspect 24 is directed to the core-shell fertilizer particle of any one of aspects 1 to 23, comprised in a fertilizer blend or a compounded fertilizer.

Aspect 25 is directed to a method of fertilizing, the method comprising applying a core-shell fertilizer particle of any one of aspects 1 to 24 to at least a portion of a soil, a crop, or the soil and the crop.

Aspect 26 is directed to a method for making the core-shell fertilizer particle of any one of aspects 1 to 24, the method comprising: providing a core having an outer surface, said core comprises urea, a pH buffering agent and an urease inhibitor; contacting at least a portion of the outer surface of the core with an urea solution; and cooling and/or drying the urea solution in contact with the at least a portion of the outer surface to form a shell.

Aspect 27 is directed to the method of aspect 26, wherein the core is made by a pelletizing press process, a compacting process, an extrusion process and/or a granulating process.

Aspect 28 is directed to the method of any one of aspects 26 or 27, wherein the contacting comprises spraying the urea solution onto the at least a portion of the outer surface of the core.

Aspect 29 is directed to the method of any one of aspects 26 to 28, wherein the urea solution is an aqueous solution comprising urea melt.

“Core-shell fertilizer particle” includes a particle that includes a core and a shell in contact with at least a portion of the outer surface of the core and covering at least a portion of the outer surface of the core. In the context of the present invention, “core-shell fertilizer particle” may also be referred to as a particle, granule, fertilizer granule, prill, or fertilizer prill.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol.%”, or “mol.%” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1 illustrates a cross section of a fertilizer particle embodiment.

### DETAILED DESCRIPTION OF THE INVENTION

The fertilizer particles of the present invention can contain two discrete portions: a core having an outer surface and a shell in contact with at least a portion of the outer surface of the core. The core can contain urea, a pH buffering agent, and an urease inhibitor. The shell can contain urea. In some aspects, the core can further contain water, a polymer thickener, and/or a nitrification inhibitor. In some aspects, the core can contain at most 2 wt. %, or less than 1 wt. %, preferably substantially free of Plaster of Paris or bleached white flour or both. In some instances, the core can contain a binder. In some instances, the pH buffer can act as a binder as well as a pH buffer. Thus the fertilizer particles of the present invention provide a solution to at least some of the previously mentioned problems associated with using Plaster of Paris and/or flour (bleached white flour) during the production process of fertilizer particles. Still further, the fertilizer particles of the present invention provide for stabilization of the urease inhibitor in the core, which can serve to protect the urea in the core and the urea in the shell from hydrolysis.

These and other non-limiting aspects of the present invention are discussed in further detail in the following sections.

### A. Core-Shell Fertilizer Particle

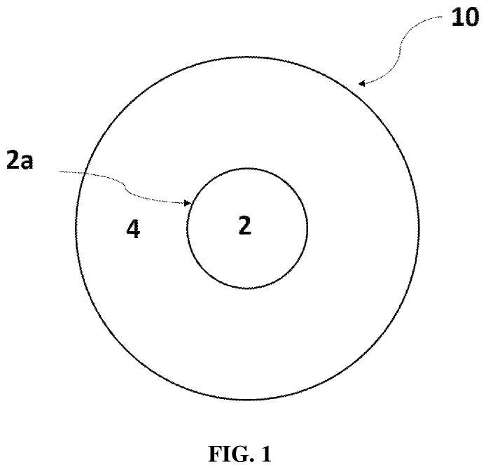

An illustrative cross-sectional view of an example of a core-shell fertilizer particle of the present invention is depicted in the FIG. 1. The fertilizer particle 10 can contain a core 2 and a shell 4. While the shape of the fertilizer particle 10 is depicted as being spherical, other shapes are contemplated (e.g., cylindrical shape, puck shape, oval shape, oblong shape, etc.). The overall shape of the fertilizer particle 10 can be influenced by the shape of the uncoated core (e.g., spherical, cylindrical, puck, oval, oblong, etc., core can result in a similarly shaped coated particle). The shell 4 can cover at least a portion of an outer surface 2a of the core 2. While for the core-shell fertilizer particle 10 depicted in the FIG. 1, the shell 4 covers entire outer surface of the core, core-shell fertilizer particles with shell covering a portion of the outer surface of the core can readily be made.

The core 2 can contain urea, a pH buffering agent, and an urease inhibitor. In some aspects, the core 2 can further contain water, a polymer thickener, a filler, and/or a nitrification inhibitor. In some aspects, the core can contain 20 wt. % to 80 wt. %, or at least, equal to, or between any two of 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, and 80 wt. %, of urea, based on the total weight of the core. In some aspects, the core can contain 15 wt. % to 80 wt. %, or at least, equal to, or between any two of 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, and 80 wt. %, of a pH buffering agent, based on the total weight of the core. In some aspects, the core can contain 0.1 wt. % to 5 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an urease inhibitor, based on total weight of the core. In some aspects, the core can contain 0.1 wt. % to 7 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 6 wt. %, and 7 wt. % of water, based on the total weight of the core. In some aspects, the core can contain 0.1 wt. % to 5 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an polymer thickener, based on the total weight of the core. In some aspects, the core can contain 5 wt. % to 35 wt. %, or at least, equal to, or between any two of 5 wt. %, 10 wt. %, 15 wt. %, 20 wt. %, 25 wt. %, 30 wt. %, and 35 wt. % of a nitrification inhibitor based on the total weight of the core. In some aspects, the core can contain 0 wt. % to 60 wt. %, or at least, equal to, or between any two of 0 wt. %, 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, and 60 wt. % of a filler based on the total weight of the core. In some aspects, the combined wt. % of the urea, CaCO₃, one or more urease inhibitor, water, and optionally a nitrification inhibitor and/or a polymer thickener in the core is 98 wt. % to 100 wt. %, or at least, equal to, or between any two 98 wt. %, 98.2 wt. % 98.4 wt. % 98.6 wt. % 98.8 wt. % 99 wt. % 99.2 wt. % 99.4 wt. % 99.6 wt. % 99.8 wt. % to 100 wt. %, based on the total weight of the core.

The shell 4 can contain urea. In some aspects, the shell 4 can contain 50 wt. % to 100 wt. %, or at least, equal to, or between any two of 50 wt. %, 55 wt. %, 60 wt. %, 65 wt. %, 70 wt. %, 75 wt. %, 80 wt. %, 85 wt. %, 90 wt. %, 95 wt. %, and 100 wt. %, of urea, based on the total weight of the shell.

In some aspects, the core 2 can contain: (1) 45 wt. % to 60 wt. %, or at least, equal to, or between any two of 45 wt. %, 46 wt. %, 47 wt. %, 48 wt. %, 49 wt. %, 50 wt. %, 51 wt. %, 52 wt. %, 53 wt. %, 54 wt. %, 55 wt. %, and 60 wt. % of urea; (2) 22 wt. % to 45 wt. %, or at least, equal to, or between any two of 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. % and 45 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; and (4) 1 wt. % to 3 wt. %, or at least, equal to, or between any two of 1 wt. %, 1.5 wt. %, 2 wt. %, 2.5 wt. %, and 3 wt. % of an urease inhibitor, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 45 wt. % to 60 wt. %, or at least, equal to, or between any two of 45 wt. %, 46 wt. %, 47 wt. %, 48 wt. %, 49 wt. %, 50 wt. %, 51 wt. %, 52 wt. %, 53 wt. %, 54 wt. %, 55 wt. %, and 60 wt. % of urea; (2) 22 wt. % to 45 wt. %, or at least, equal to, or between any two of 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, and 45 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; and (5) 20 wt. % to 25 wt. %, or at least, equal to, or between any two of 20 wt. %, 21 wt. %, 22 wt. %, 23 wt. %, 24 wt. %, and 25 wt. % of a nitrification inhibitor, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 45 wt. % to 60 wt. %, or at least, equal to, or between any two of 45 wt. %, 46 wt. %, 47 wt. %, 48 wt. %, 49 wt. %, 50 wt. %, 51 wt. %, 52 wt. %, 53 wt. %, 54 wt. %, 55 wt. %, and 60 wt. % of urea; (2) 22 wt. % to 45 wt. %, or at least, equal to, or between any two of 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. % and 45 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; and (5) 0.5 wt. % to 5 wt. %, or at least, equal to, or between any two of 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of a polymer thickener, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 45 wt. % to 60 wt. %, or at least, equal to, or between any two of 45 wt. %, 46 wt. %, 47 wt. %, 48 wt. %, 49 wt. %, 50 wt. %, 51 wt. %, 52 wt. %, 53 wt. %, 54 wt. %, 55 wt. %, and 60 wt. % of urea; (2) 22 wt. % to 45 wt. %, or at least, equal to, or between any two of 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, and 45 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; (5) 20 wt. % to 25 wt. %, or at least, equal to, or between any two of 20 wt. %, 21 wt. %, 22 wt. %, 23 wt. %, 24 wt. %, and 25 wt. % of a nitrification inhibitor; and (6) 0.5 wt. % to 5 wt. %, or at least, equal to, or between any two of 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of a polymer thickener, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell

In some aspects, the core 2 can contain: (1) 65 wt. % to 75 wt. %, or at least, equal to, or between any two of 65 wt. %, 66 wt. %, 67 wt. %, 68 wt. %, 69 wt. %, 70 wt. %, 71 wt. %, 72 wt. %, 73 wt. %, 74 wt. %, and 75 wt. % of urea; (2) 20 wt. % to 30 wt. %, or at least, equal to, or between any two of 20 wt. %, 22 wt. %, 23 wt. %, 24 wt. %, 25 wt. %, 26 wt. %, 27 wt. %, 28 wt. %, 29 wt. %, and 30 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; and (4) 1 wt. % to 3 wt. %, or at least, equal to, or between any two of 1 wt. %, 1.5 wt. %, 2 wt. %, 2.5 wt. %, and 3 wt. % of an urease inhibitor, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 65 wt. % to 75 wt. %, or at least, equal to, or between any two of 65 wt. %, 66 wt. %, 67 wt. %, 68 wt. %, 69 wt. %, 70 wt. %, 71 wt. %, 72 wt. %, 73 wt. %, 74 wt. %, and 75 wt. % of urea; (2) 20 wt. % to 30 wt. %, or at least, equal to, or between any two of 20 wt. %, 22 wt. %, 23 wt. %, 24 wt. %, 25 wt. %, 26 wt. %, 27 wt. %, 28 wt. %, 29 wt. %, and 30 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; and (5) 0.5 wt. % to 5 wt. %, or at least, equal to, or between any two of 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of a polymer thickener, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 20 wt. % to 75 wt. %, or at least, equal to, or between any two of 20 wt. %, 25 wt. %, 30 wt. %, 35 wt. %, 40 wt. %, 45 wt. %, 50 wt. %, 55 wt. %, 60 wt. %, 65 wt. %, 70 wt. %, and 75 wt. % of urea; (2) 20 wt. % to 60 wt. %, or at least, equal to, or between any two of 20 wt. %, 25 wt. %, 30 wt. %, 35 wt. %, 40 wt. %, 45 wt. %, 50 wt. %, 55 wt. %, and 60 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; and (5) 0.5 wt. % to 5 wt. %, or at least, equal to, or between any two of 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of a polymer thickener, based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 20 wt. % to 75 wt. %, or at least, equal to, or between any two of 20 wt. %, 25 wt. %, 30 wt. %, 35 wt. %, 40 wt. %, 45 wt. %, 50 wt. %, 55 wt. %, 60 wt. %, 65 wt. %, 70 wt. %, and 75 wt. % of urea; (2) 20 wt. % to 60 wt. %, or at least, equal to, or between any two of 20 wt. %, 25 wt. %, 30 wt. %, 35 wt. %, 40 wt. %, 45 wt. %, 50 wt. %, 55 wt. %, and 60 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; (5) 0.5 wt. % to 5 wt. %, or at least, equal to, or between any two of 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of a polymer thickener; and (6) 20 wt. % to 25 wt. %, or at least, equal to, or between any two of 20 wt. %, 21 wt. %, 22 wt. %, 23 wt. %, 24 wt. %, and 25 wt. % of a nitrification inhibitor based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the core 2 can contain: (1) 20 wt. % to 75 wt. %, or at least, equal to, or between any two of 20 wt. %, 25 wt. %, 30 wt. %, 35 wt. %, 40 wt. %, 45 wt. %, 50 wt. %, 55 wt. %, 60 wt. %, 65 wt. %, 70 wt. %, and 75 wt. % of urea; (2) 20 wt. % to 60 wt. %, or at least, equal to, or between any two of 20 wt. %, 25 wt. %, 30 wt. %, 35 wt. %, 40 wt. %, 45 wt. %, 50 wt. %, 55 wt. %, and 60 wt. % of a pH buffering agent; (3) 0.1 wt. % to 7 wt. %, or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, and 7 wt. % of water; (4) 1 wt. % to 3 wt. %, or at least, equal to, or between any two of 1 wt. %, 1.5 wt. %, 2 wt. %, 2.5 wt. %, and 3 wt. % of an urease inhibitor; and (5) 20 wt. % to 25 wt. %, or at least, equal to, or between any two of 20 wt. %, 21 wt. %, 22 wt. %, 23 wt. %, 24 wt. %, and 25 wt. % of a nitrification inhibitor based on the total weight of the core. The shell 4 can contain 85 wt. % to 100 wt. %, or at least, equal to, or between any two of 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, and 100 wt. %, of urea, based on the total weight of the shell.

In some aspects, the urease inhibitor can include a thiophosphoric triamide derivative, and/or phenyl phosphorodiamidate (PPDA). In some aspects, the thiophosphoric triamide derivatives can be N-(n-butyl) thiophosphoric triamide (NBPT), and/or N-(n-propyl) thiophospshoric triamide (NPPT). In some aspects, the urease inhibitor can include NBPT.

In some aspects, the pH buffering agent can be CaCO₃, MgO, KH₂PO₄, NaHCO₃, aluminum, magnesium hydroxide, aluminum hydroxide/magnesium hydroxide co-precipitate, aluminum hydroxide/sodium bicarbonate co-precipitate, calcium acetate, calcium bicarbonate, calcium borate, calcium carbonate, calcium bicarbonate, calcium citrate, calcium gluconate, calcium hydroxide, dibasic sodium phosphate, dipotassium hydrogen phosphate, dipotassium phosphate, disodium hydrogen phosphate, magnesium acetate, magnesium borate, magnesium bicarbonate, magnesium carbonate, magnesium hydroxide, magnesium lactate, magnesium oxide, magnesium phosphate, magnesium silicate, magnesium succinate, magnesium tartrate, potassium acetate, potassium carbonate, potassium bicarbonate, potassium borate, potassium citrate, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium tartrate, sodium tripolyphosphate, synthetic hydrotalcite, tetrapotassium pyrophosphate, tetrasodium pyrophosphate, tripotassium phosphate, trisodium phosphate, and trometamol, and combinations thereof. In some aspects, the pH buffering agent can be CaCO₃. In some aspects, the CaCO₃ can be included as chalk powder.

In some aspects, the filler can contain one or more of silica, dried distillers grains with solubles (DDGS), CaCO₃, MgO, CaO, bone mill powder, or rice husk, or mixtures thereof. Other suitable fillers known in the art may also be used. In some aspects, a pH buffering agent can also function as a filler. For example, in some aspects, CaCO₃ is used as both the filler and as the pH buffering agent. In some instances, no other fillers or pH buffering agents other than CaCO₃ are included in the core particle.

In some aspects, the nitrification inhibitors can include 3,4-dimethylpyrazole phosphate (DMPP), thio-urea (TU), dicyandiamide (DCD), 2-Chloro-6-(trichloromethyl)-pyridine (Nitrapyrin), 5- Ethoxy-3-trichloromethyl -1, 2, 4-thiadiazol (Terrazole), 2-Amino-4-chloro-6-methyl- pyrimidine (AM), 2-Mercapto-benzothiazole (MBT), or 2-Sulfanimalamidothiazole (ST) or any combination thereof, preferably DCD.

In some aspects, the polymer thickener can be hydroxypropyl methylcellulose (HPMC), carboxymethylcellulose, hydroxyethylcellulose, polyethylene glycol (PEG), guar gum, locust bean gum, xanthan gum, other natural gums, synthetic polymers based on acrylates, polyacrylamide (PAM), PVP, combinations of synthetic polymers, or carbomers, any combination thereof. In some aspects, polymer thickening agent can be HPMC.

A number of urease inhibitors and nitrification inhibitors have been developed to enhance the efficiency of urea fertilizer. But their application can be challenging due to stability problems of some the urease inhibitors and/or nitrification inhibitors under various conditions such as pH, temperature, precipitation, etc. For example, NBPT is known to be a good inhibitor of urease but it is unstable under acidic pH. NBPT also decomposes when exposed directly to high temperatures, such as the temperature of a urea melt (about 135-140° C.). In the case of nitrogen containing fertilizers, after application, the soil environment can become acidic. Accordingly, urease inhibitors and/or nitrification inhibitors that are sensitive to the acidic pH degrade and will not reach their full performance capability. Including a large excess of urease inhibitors and/or nitrification inhibitors to compensate for the loss due to pH variations may not be successful, since the fertilizers, which are present in a large excess (in comparison to the urease inhibitors and/or nitrification inhibitors), continue to alter the pH of the soil environment. Also, some commercial products, such as SuperU®, use organic solvents like NMP for adding urease inhibitors and/or nitrification inhibitors to the fertilizer composition.

The core-shell fertilizer particles of the present invention provide a solution to at least some of these issues. The urea and pH buffering agent in the core and urea in the shell results in a core-shell structure that can protect the urease inhibitor(s) and/or the nitrification inhibitor(s) from degradation during the manufacture of the core (e.g., protection from high temperatures, high pressures, acidic pH conditions, etc.).

The urea in the shell can first come in contact with the soil, protecting the urease inhibitor and nitrification inhibitor in the core, which will get released gradually. The core can contain urea and a pH buffering agent. The pH buffering agent can neutralize the acidity caused by urea hydrolysis, thereby preventing the urease inhibitors, such as, for example, NBPT, from degrading when placed in soil with an acidic pH. Thus, the pH buffering agent can increase the efficacy of urease inhibitors, for example, NBPT, and also maintains soil pH. In some aspects, certain pH buffering agent can also function as a thermal masking material for other ingredient in the core, such as NBPT, and act as an filler. For example, in some embodiments, CaCO₃ can used as pH buffering agent and filler. The urea in the fertilizer core can protect the urease inhibitor and the nitrification inhibitor, from being exposed to high temperatures during the core manufacturing process (e.g., granulation process), thereby reducing the likelihood of the urease inhibitor and the nitrification inhibitor from decomposing in the manufacturing process. CaCO₃ in the core can also reduce the likelihood of NBPT degradation during the core manufacturing process (e.g., granulation process). CaCO₃ can function as both pH buffering agent and a filler material and can improve the physical properties of the core, such as crush strength, homogeneity, and the release kinetics of inhibitors from the core particle. The polymer thickener can function as a plasticizer and promote desired continuous and uniform flow characteristics of a mixture used in forming the core.

The core of the core-shell fertilizer particles of the present invention can contain no more than 2 wt. %, or less than 1 wt. %, or less than 0.5 wt. %, or less than 0.1 wt. % or substantially free of Plaster of Paris (POP), flour(s) such as wheat flour such as bleached wheat flour (BWF), starch, gluten, kaolin, bentonite, colloidal silica, polyethylene glycol, and/or polycaprolactone.

In some aspects, additional fertilizer substances besides urea can be included or excluded in the core and/or shell of the core-shell fertilizer particles. If included, additional fertilizers can be chosen based on the particular needs of certain types of soil, climate, or other growing conditions to maximize the efficacy of the fertilizer particle in enhancing plant growth and crop yield. Additional additives may also be included or excluded in the fertilizer particles. Non-limiting examples of additives that can be included or excluded from the fertilizer particles of the present invention include micronutrients, additional nitrogen nutrients, and/or secondary nutrients. A micronutrient is a botanically acceptable form of an inorganic or organometallic compound such as boron, copper, iron, chloride, manganese, molybdenum, nickel, or zinc. An additional nitrogen nutrient is a nutrient other than urea can deliver nitrogen to a plant. In some aspects, the additional nitrogen nutrient can include ammonium nitrate, ammonium sulfate, diammonium phosphate, monoammonium phosphate, urea-formaldehyde, ammonium chloride, and potassium nitrate. A secondary nutrient is a substance that can deliver calcium, magnesium, and/or sulfur to a plant. In some aspects, the secondary nutrients may include lime, gypsum, superphosphate, or a combination thereof.

The core of the core-shell fertilizer particles can have desirable physical properties such as desired levels of abrasion resistance, particle strength, pelletizability, hygroscopicity, particle shape, and size distribution, which are important properties for the fertilizer core.

The fertilizer particles described herein can be comprised in a composition useful for application to soil. In addition to the fertilizer particles, the composition may include other fertilizer compounds, micronutrients, primary nutrients, additional urea, additional nitrogen nutrients, insecticides, herbicides, or fungicides, or combinations thereof.

The fertilizer particles described herein can also be included in a blended composition comprising other fertilizer granules. The other fertilizer granules can be granules of urea, Single Super Phosphate (SSP), Triple Super Phosphate (TSP), ammonium sulfate and the like.

### B. Method of Making a Fertilizer Particle

The core can be formed by a pelletizing process such as a pelletizing press process, a compacting process, an extrusion process, or a granulating process.

In some aspects, the pelletizing press process of core formation can include, forming a powdered composition by mixing the core ingredients such as urea, a pH buffering agent, an urease inhibitor, and optionally a nitrification inhibitor, a filler, and/or a polymer thickener in dry form and pressing the powdered composition through a die to form a pelletized core of a desired shaped. The pelletizing press process can be done using a pelletizing press known in the art. In some aspects, core ingredients can be mixed in a mixer, such as a turbo mixer to form the powdered composition, the powdered composition from the mixer can be fed to a screw feeder connected to a pelletizing press. In some aspects, the powdered composition can be fed to the screw feeder at a rate 40 kg/hr to 100 kg/h, or 50 kg/hr to 80 kg/h. In some aspects, the pelletizing press can include twin rollers rotating at a speed 150 to 200 RPM and the powdered composition can be pressed through the die by the rollers.

In some aspects, the compacting process of core formation can include, forming a powdered composition by mixing the core ingredients such as urea, a pH buffering agent, an urease inhibitor, and optionally a nitrification inhibitor, a filler, and/or a polymer thickener in dry form, compacting the powdered composition to form a compacted composition and crushing, grinding and/or granulating the compacted composition to form the core of desired shape and size. The compacting process can be done using a roller compactor known in the art. In some aspects, the powdered composition can be compacted by feeding the powdered composition into a roller compactor containing a rotating roller and a roller in immobile phase, and forming a compacted composition in form of a sheet from the powdered composition.

In some aspects, the granulation process of core formation can include preparing a powder composition containing a pH buffering agent, an urease inhibitor, and, optionally a nitrification inhibitor, a filler, and/or a polymer thickener and contacting the powder composition with a molten urea composition under conditions sufficient to form a plurality of solid particles containing the powder composition embedded within a solid urea matrix. In some aspects, the contacting condition of the powder composition and the molten urea composition can include spraying the molten urea composition onto the powder composition. In some aspects, the molten urea composition can be an aqueous urea melt solution (e.g., 90 wt. % -96 wt. % urea)

In some aspects, the extrusion process of core formation can include, forming a extrudable composition containing urea, a pH buffering agent, an urease inhibitor, and optionally a nitrification inhibitor, a filler and/or a polymer thickener, and extruding the extrudable composition. The method may also include a drying step after extruding to remove solvent that may have been added to make the composition extrudable. In some aspects, the extrudable composition can be formed by mixing urea, a pH buffering agent, an urease inhibitor, and optionally a nitrification inhibitor, a filler and/or a polymer thickener in dry form, adding any solvent, if needed. In some aspects, the solvent can be water. The extrusion can be done using suitable extruder apparatus known in the art and can be performed at a temperature between 0° C. and 150° C. and a screw speed from 1 to 500 rpm, wherein the extruder comprises a multi-feeder comprising extrusion components including a main drive, shaft, screw, barrel, and/or die.

The core can then be contacted with an urea solution or melted urea to form a urea-based shell, thereby forming a core-shell fertilizer particle. The contacting can include spraying the urea solution or urea melt onto the core particle at a temperature 100° C. to 145° C. or at least, equal to, or between any two of 100° C., 105° C., 110° C., 115° C., 120° C., 125° C., 130° C., 135° C., 140° C., and 145° C. As the urea solution or urea melt is sprayed onto the core particle, it can be cooled and dried to form a solidified outer coating or shell on at least a portion of an outer surface of the core, which can result in a core-shell fertilizer particle of the present invention. The resulting fertilizer particle can be of various sizes and shapes. In some aspects, the urea solution can be aqueous urea solution containing 80 wt. % to 98 wt. % or at least, equal to, or between any two of 80 wt. %, 95 wt. %, 90 wt. %, 91 wt. %, 92 wt. %, 93 wt. %, 94 wt. %, 95 wt. %, 96 wt. %, and 98 wt. % of urea.

### C. Methods of Using Fertilizer Particles

The core-shell fertilizer particles of the present invention can be used in methods of increasing the amount of nitrogen in soil and of enhancing plant growth. Such methods can include applying to the soil an effective amount of a composition comprising the core-shell fertilizer particles of the present invention. The method may include increasing the growth and yield of crops, trees, ornamentals, etc. such as, for example, palm, coconut, rice, wheat, corn, barley, oats, and soybeans. The method can include applying core-shell fertilizer particles of the present invention to at least one of a soil, an organism, a liquid carrier, a liquid solvent, etc.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, Symplocaceae, Tamaricaceae, Theaceae, Theophrastaceae, Thymelaeaceae, Tiliaceae, Ulmaceae, Verbenaceae, and/or Vitaceae family.

The effectiveness of compositions comprising the core-shell fertilizer particles of the present invention can be ascertained by measuring the amount of nitrogen in the soil at various times after applying the fertilizer composition to the soil. It is understood that different soils have different characteristics, which can affect the stability of the nitrogen in the soil. The effectiveness of a fertilizer composition can also be directly compared to other fertilizer compositions by doing a side-by-side comparison in the same soil under the same conditions.

In one aspect, the core-shell fertilizer particles of the present invention can have a density that is greater than water. This can allow the particles to sink in water rather than float. This can be especially beneficial in instances where application is intended to a crop that is at least partially or fully submerged in water. A non-limiting example of such a crop is rice, as the ground in a rice paddy is typically submerged in water. Thus, application of core-shell fertilizer particles to such crops can be performed such that the core-shell fertilizer particles are homogenously distributed on the ground that is submerged under water. By comparison, particles that have a density that is less than water would have a tendency to remain in or on the water surface, which could result in washing away of the particles and/or coalescence of the particles, either of which would not achieve homogenous distribution of the particles to the ground that is submerged under water.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Methods of Making Fertilizer Particles

Materials: Technical grade urea was obtained from SABIC (Riyadh, Kingdom of Saudi Arabia). Chalk powder was used as a source for CaCO₃. Hydroxypropylmethylcellulose (HPMC) was obtained from Loba Chemie Pvt. Ltd. (Mumbai, India). N-(n-butyl) thiophosphoric triamide (NBPT) was purchased from Samich (HK) Ltd. (Hangzhou, China). DCD was obtained from Sigma Aldrich.

Procedure for Preparing the Core: Four sample core compositions are shown in Table 1. The cores were prepared with a pellet press by the following method. Core ingredients were mixed using a turbo-mixer MTI in dry powder form for about 30 seconds. The dry mixed powder was discharged out from the mixer and fed into a screw feeder, which was connected to a pelletizing press. Then the mixture was fed into the press at 50 to 80 kg/hour. The press contained twin rollers that were rotating at 150 to 200 RPM. The dry mass was pressed through a die with 1 mm holes, and compressed into cylindrical strands. Further, these strands were cut into pellets by knives placed under the die. Then the cylindrical pellets were cooled in an air suction chamber. The core pellets were substantially cylindrical shape with a length of 0.7 mm to 1.6 mm and a diameter of 0.8 mm to 1.2 mm.

TABLE 1
Composition of the core

| | Urea | Chalk | HPMC | NBPT | DCD |
|---|---|---|---|---|---|
| | (wt. | Powder | (wt. | (wt. | (wt. |
| | %) | (wt. %) | %) | %) | %) |
| Sample 1 | 94.8 | 0 | 3 | 2.2 | 0 |
| (Comparative sample) | | | | | |
| Sample 2 | 50.8 | 25 | 0 | 2.2 | 22 |
| Sample 3 | 71.3 | 25 | 1.5 | 2.2 | 0 |
| Sample 4 | 56.3 | 40 | 1.5 | 2.2 | 0 |

Procedure for Coating the Core: The core pellets were coated with an aqueous urea melt solution (90-96% urea) in a granulator. The solution was then dried to form a solidified urea shell on the outer surface of the pellets to form the core-shell fertilizer particles. The granulator bed temperature was 80° C. to 110° C.

### Example 2

### Method for Quantifying the NBPT and DCD Inhibitors by HPLC

NBPT and DCD quantification in the core particles: Core particles were stored at room conditions and analyzed for inhibitor content after 21, 44, 63, 101, 151 and 236 days of preparation. Approximately 1 g of the core particles described in Table 1 were weighted into a mortar and crushed with a pestle to make powder. 200 mg of the powdered sample was added (in triplicate) into polypropylene tubes with 10 mL of a diluent (acetonitrile:water, 50:50). The samples were sonicated for 30 mins with intermediate shaking and vortexed for 1 hr using a vortex shaker. The vortexed sample was filtered using a 0.45 μm syringe filter into a High Performance Liquid Chromatography (HPLC) vial and analyzed by HPLC. See Tables 2 and 3. For DCD samples, filtered solution was diluted 10× prior to HPLC analysis. Inhibitor quantification was obtained using a calibration curve. Results are presented in Table 4. The results show formulations of the current invention stabilize the inhibitors.

NBPT and DCD quantification in the core-shell particles: Core-shell particles were stored at room conditions and analyzed for inhibitor content after 90, 162, and 195 days of preparation. Approximately 4 g of core-shell fertilizer particles prepared as described in Example 1, using cores as described in Table 1, were added into polypropylene tubes and 20 mL of a diluent was added (in triplicate). The samples were sonicated for 30 mins with intermediate shaking and vortexed for 1 hr using a vortex shaker. The vortexed sample was filtered using a 0.45 μm syringe filter into a HPLC vial and analyzed by HPLC. See Tables 2 and 3. For DCD samples, filtered solution was diluted 20× prior to HPLC analysis. Inhibitor quantification was obtained using a calibration curve. Results are presented in Table 4. The results show formulations of the current invention stabilize the inhibitors.

TABLE 2
Chromatographic conditions for NBPT quantification

| Method name | NBTPT + DCD.1cm | |
|---|---|---|
| Column | Phenomenex, Luna Pnenyl hexyl 250*4.6, 5 μ | |
| Column oven | 35° | C. |
| temperature | | |
| Injection Vol. | 5 | μL |
| Flow rate | 1.00 | mL/min |
| Mobile Phase | Reservoir A: Milli-Q Water, | |
| | Reservoir C: Acetonitrile | |
| | Isocratic: Milli-Q water: Acetonitrile (80:20 v/v) | |
| Run Time | 15 | mins |
| Wavelength | 207 | nm |

TABLE 3
Chromatographic conditions for DCD quantification

| Method name | DCD_7.1cm | |
|---|---|---|
| Wash method | DCD_7_Wash Method.1cm | |
| Column | Zorbax NH2, 150 × 4.6 mm, 5 micron | |
| Column oven | 30° | C. |
| temperature | | |
| Injection Vol. | 5 | μL |
| Flow rate | 1.50 | mL/min |
| Mobile Phase | Reservoir A: Milli Q Water | |
| | Reservoir B: Methanol | |
| | Reservoir C: Acetonitrile | |
| Wavelength | 217 | nm |

| | | Milli Q | | |
|---|---|---|---|---|
| | Time(mL) | water | Methanol | Acetonitrile |
| Gradient | 0.01 | 1 | 2 | 97 |
| program | 4.00 | 8 | 2 | 90 |
| | 4.50 | 8 | 2 | 90 |
| | 8.00 | 3 | 2 | 95 |
| | 14.00 | 1 | 2 | 97 |
| | 15.00 | 1 | 2 | 97 |

| | |
|---|---|
| 15.00 | Controller Stop |

Results: Results presented in Table 4 show NBPT in the core particle with mostly urea (Sample 1) degrades faster compared to that in core particles containing chalk power with urea (Samples 2, 3, and 4). Thus chalk power included in the core stabilizes the inhibitors in the core. Similarly results presented in Table 5 show chalk power included in the core stabilizes the inhibitors in the core of the core-shell particles. NBPT for a core-shell particle using the core of Sample 1 (control) is expected to be substantially lower than for the cores of Samples 2, 3, and 4, due at least in part to degradation that is expected because of exposure of the core to the high heat of the urea melt used to coat the core.

TABLE 4
Inhibitor recovery from core particles stored at room conditions

| Core | | | | | % DCD |
|---|---|---|---|---|---|
| Particle | % NBPT Recovery | | | | Recovery |
| Age (Days) | Sample 1 | Sample 2 | Sample 3 | Sample 4 | Sample 2 |
| 21 | 91.2 | 97.0 | 93.9 | 95.0 | Not Done |
| 44 | 92.6 | 99.6 | 94.1 | 91.4 | 94.7 |
| 63 | 87.7 | 97.7 | 89.1 | 89.9 | 96.0 |
| 101 | 91.8 | 94.7 | 92.0 | 93.8 | 94.5 |
| 151 | 81.6 | 93.5 | 90.0 | 93.9 | 99.7 |
| 236 | 60.9 | 88.0 | 83.1 | 90.9 | 87.5 |

The amount of inhibitor recovered on 0 day (granulation day) was considered as 100% for the recovery calculations. The Sample numbers correlate with the Samples shown in Table 1.

TABLE 5
Inhibitor recovery in the core-shell particles stored at room conditions

| Core-Shell | | | | DCD |
|---|---|---|---|---|
| particles age | NBPT Recovery, % | | | Recovery, % |
| (days) | Sample 2 | Sample 3 | Sample 4 | Sample 2 |
| 90 days | 96.8 | 103.7 | 93.6 | 93.5 |
| 162 days | 96.5 | 102.5 | 94.0 | 91.5 |
| 195 days | 80.7 | 90.2 | 93.5 | 90.5 |

The amount of inhibitor recovered on 0 day (granulation day) was considered as 100% for the recovery calculations. The Sample numbers correlate with the Sample numbers for cores of Table 1 used in forming the core-shell particles.

1. A core-shell fertilizer particle comprising:
a core comprising urea, a pH buffering agent, and an urease inhibitor; and
a shell comprising urea, wherein the shell covers at least a portion of an outer surface of the core.

2. The core-shell fertilizer particle of claim 1, wherein the core comprises 20 wt. % to 80 wt. % urea, based on the total weight of the core.

3. The core-shell fertilizer particle of claim 1, wherein the shell comprises 50 wt. % to 100 wt. % urea, based on the total weight of the shell.

4. The core-shell fertilizer particle of claim 1, wherein the core comprises 15 wt. % to 80 wt. % of the pH buffering agent based on the total weight of the core.

5. The core-shell fertilizer particle of claim 1, wherein the pH buffering agent is CaCO₃, Na₂CO₃, K₂CO₃, MgO, KH₂PO₄, NaHCO₃, or MgCO₃, or any combination thereof.

6. The core-shell fertilizer particle of claim 1, wherein the urease inhibitor comprises a thiophosphoric triamide derivative.

7. The core-shell fertilizer particle of claim 1, wherein the core comprises 0.1 wt. % to 5 wt. % of the urease inhibitor, based on the total weight of the core.

8. The core-shell fertilizer particle of claim 1, wherein the core further comprises 0.1 wt. % to 7 wt. % of water, based on the total weight of the core.

9. The core-shell fertilizer particle of claim 1, wherein the core further comprises a polymer thickener and/or a filler.

10. The core-shell fertilizer particle of claim 9, wherein the polymer thickener comprises hydroxypropyl methylcellulose (HPMC), carboxymethyl cellulose, polyethylene glycol (PEG), guar gum, locust bean gum, xanthan gum, a natural gum, lignosulfonate, or hydroxyethylcellulose or any combination thereof.

11. The core-shell fertilizer particle of claim 9, wherein the core comprises 0.1 wt. % to 5 wt. % of the polymer thickener, based on the total weight of the core.

12. The core-shell fertilizer particle of claim 1, wherein the core further comprises a nitrification inhibitor.

13. The core-shell fertilizer particle of claim 12, wherein the nitrification inhibitor comprises dicyandiamide (DCD).

14. The core-shell fertilizer particle of claim 12, wherein the core comprises 5 wt. % to 35 wt. % of the nitrification inhibitor, based on the total weight of the core.

15. The core-shell fertilizer particle of claim 1, wherein 98 wt. % or higher of the core, based on the total weight of the core, is comprised in urea, CaCO₃, one or more urease inhibitor, water, and optionally a nitrification inhibitor and/or a polymer thickener.

16. The core-shell fertilizer particle of claim 1, wherein:
the core comprises, based on the total weight of the core:
45 wt. % to 60 wt. % or 65 wt. % to 75 wt. % of urea;
20 wt. % to 60 wt. %, preferably 20 wt. % to 45 wt. %, of CaCO₃;
1 wt. % to 3 wt. % of the urease inhibitor, wherein the urease inhibitor is N-(n-butyl) thiophosphoric triamide (NBPT);
0.1 wt. % to 3 wt. % of water; and
the shell comprises, based on the total weight of the shell:
85 wt. % to 100 wt. % urea.

17. The core-shell fertilizer particle of claim 16, wherein the core further comprises

0. 5 wt. % to 3 wt. % of hydroxypropyl methylcellulose (HPMC), based on the total weight of the core.

18. The core-shell fertilizer particle of claim 16, wherein the core further comprises 20 wt. % to 25 wt. % of dicyandiamide (DCD), based on the total weight of the core.

19. The core-shell fertilizer particle of claim 1, wherein the shell does not include CaCO₃ or a urease inhibitor, or both.

20. The core-shell fertilizer particle of claim 1, comprised in a fertilizer blend or a compounded fertilizer.
